(19) United States
(12) Patent Application Publication
(10) Pub. No.: US 2010/0116033 A1
(43) Pub. Date: May 13, 2010

(54) DRY POWDER RHEOMETER

(76) Inventors: Lee Paul Hoenderkamp, Herfordshire (GB); William Kerckhoff Young, Herfordshire (GB)

Correspondence Address: GLAXOSMITHKLINE;CORPORATE INTELLECTUAL PROPERTY, MAI B482, FIVE MOORE DR., PO BOX 13398, RESEARCH TRIANGLE PARK, NC, 27709-3398, US

(21) Appl. No.: 12/532,904

(22) PCT Filed: Mar. 24, 2008
(86) PCT No.: PCT/US08/57960

§ 371 Date: Sep. 24, 2009

Related U.S. Application Data
(60) Provisional application No. 60/908,248, filed on Mar. 27, 2007.

(51) Int. Cl. G01N 11/14

(52) U.S. Cl. 73/54.28

(57) ABSTRACT

A system and method for characterizing a rheological property of a particulate or powdered pharmaceutical composition having a sensor that measures the force imparted to a powder interacting member disposed within a quantity of moving powder. The measured force is related to a rheological property of the pharmaceutical composition, such as viscosity, flowability or compressibility. Information regarding the pharmaceutical composition's rheological properties allows increased performance in the automated loading of precise amounts of a powdered drug into a dry powder inhaler.

### FIELD OF THE PRESENT INVENTION

The present invention relates to methods and systems for characterizing the physical properties of powders. More specifically, the invention relates to a method and system for assessing the rheological properties of particulate or powdered pharmaceutical compositions in real-time during a manufacturing process.

### BACKGROUND OF THE INVENTION

As is well known in the art, dry powder inhalers (DPIs) are typically employed to deliver a particulate or powdered pharmaceutical composition into the airway of a subject. DPIs offer a number of advantages, including the ability to deliver precisely metered doses of the pharmaceutical composition, facilitation of self-administration, reduced potential for drug side-effects, relative ease of delivery by inhalation, and elimination of needles, among others. Furthermore, adjusting the particle size of the pharmaceutical composition allows the pharmaceutical composition to be preferentially delivered to specific areas of the subject's respiratory system.

Another advantage is that DPIs can be breath-activated, providing automatic discharge of the pharmaceutical composition in coordination with the subject's breathing. In contrast, conventional metered dose inhalers require a subject to inhale at the proper time while manually activating the delivery device to ensure that a proper dose of the pharmaceutical composition is delivered into the respiratory system. By automatically synchronizing delivery with the subject's breathing, DPIs can avoid the timing problems associated with manually-activated inhalers.

As is also well known in the art, current DPI designs include pre-metered and device-metered inhalers. Each inhaler can be driven by inspiration alone, as described above, or can be power-assisted.

Pre-metered DPIs contain pre-measured, self-contained doses or dose fractions of the pharmaceutical composition (e.g., single or multiple presentations in blisters, capsules, or other cavities) that are inserted into the device during manufacture or by the subject before use. In these designs, the dose can be inhaled directly from the pre-metered unit or it can be transferred to a chamber before being inhaled by the subject.

The above noted features make the use of DPIs a desirable method for delivering a number of pharmaceutical compositions. For example, in the treatment of asthma, both quick relief pharmaceutical compositions, such as bronchodilators, and long-term control compositions, such as corticosteroids, can be delivered effectively to a subject's airways using a DPI.

DPIs inherently require that the pharmaceutical composition be formulated as a dry powder. The powder can simply comprise the neat drug or active that is controlled to a suitable particle size distribution or can comprise the active contained within a matrix of excipients and/or carrier particles.

However, regardless of the powder formulation, the physical attributes of the powder greatly impact the reproducibility of the dose and the effective delivery of the pharmaceutical composition. Accurately characterizing these qualities to ensure proper manufacture and to maintain functionality of the device throughout its lifetime under use conditions presents a formidable challenge.

Some important attributes of a particulate or powdered composition, both in terms of loading the powdered composition into the delivery device and the delivery of the powdered composition into the subject's airway, are its rheological properties. These properties are believed to affect the way a powder moves and deforms in response to various forces. Attributes associated with a material's rheology include flowability and viscosity.

Unfortunately, it has been difficult to characterize and adequately predict the rheological characteristics of powders, particularly, powdered pharmaceutical compositions. As noted above, powdered pharmaceutical compositions typically comprise complex mixtures of different materials that are blended to produce the desired characteristics. Accordingly, the different materials can exhibit a wide range of material response(s) that also affect the characteristics of the powder composition as a whole.

A primarily source of the perceived difficulty in characterizing a powdered pharmaceutical composition is the number and variability of intrinsic and extrinsic factors that affect a powder's rheology. Intrinsic factors can include the particle size, size distribution, morphology, bulk density, compatibility and compressibility, surface texture, cohesivity, surface coating, wear or attrition characteristics, hardness, stiffness, fracture toughness, and propensity for physical interactions, including electrostatic, gravitational, fluid dynamic, van der Waals, capillary forces and other interactive forces. Extrinsic factors can include compaction condition, vibration, temperature, humidity, electrostatic charge, aeration, handling history, storage time and interactions with surfaces during manufacture, storage and delivery. All of these intrinsic and extrinsic factors can greatly affect the ability of a given process to accurately load a DPI with a powdered pharmaceutical composition and are capable of having a significant impact on the subsequent delivery of the powdered composition to a subject.

Therefore, during the manufacture of DPIs, it is typically essential to fill the powdered pharmaceutical composition into the storage compartments in a highly precise and reproducible manner. Typically, the automated filling process is either immersion or compression based. However, regardless of the fill method employed, the powdered compositions characteristics that influence the filling of the DPI should be accurately measured. It is also desirable to measure these properties continuously, in real-time, while the pharmaceutical composition is being supplied to the filling process to ensure that changes in the composition's characteristics are minimized or do not alter the dose or its delivery characteristics.

Traditional approaches to assessing the characteristics of a particulate material or powder typically include single-point viscosity tests performed using empirical techniques, such as determining the angle of repose. However, such measurements can oversimplify the complex rheological response of a powder by focusing on a single parameter. For the most part, empirical techniques thus offer inadequate insight into the full rheological profile of particulate materials and do not provide sufficient precision for facilitating the manufacture of DPIs.

Several prior art rheometers have also been used to characterize the attributes of powders and other particulate materials. For example, U.S. Pat. No. 6,971,262 discloses a system for measuring the viscoelastic properties of a particulate material by imparting a shear force to a sample contained in a cup. The force is transmitted by a rotating vane while the sample is vibrated. According to the invention, the particulate material's characteristics can be derived by measuring the strain imparted to the cup.

Similar systems for measuring the viscosity of slurries, powders or liquids are disclosed in U.S. Pat. Nos. 7,021,123, 6,997,045, 6,227,039, 6,065,330, and 5,321,974. The noted prior art references all disclose self-contained systems that employ a rotating member to impart a force through the sample. As such, these systems are adapted to analyze discrete samples of a given material and are not believed to be configured to be integrated into an automated manufacturing process.

In U.S. Pat. No. 6,158,293, a further prior art system is disclosed. The system disclosed in the '293 patent measures the flowability of a powder using a rotating drum and a torque loading sensor that assesses the force of an avalanching powder. This reference is thus also directed to the testing of discrete samples.

Another prior art system for testing powders is disclosed in U.S. Pat. No. 5,140,861, wherein shear forces are measured by drawing a sled across a stationary powder bed. The system is thus believed to be similarly limited to testing discrete samples.

In U.S. Pat. No. 4,766,761, another prior art system is disclosed for measuring a specific property of a particulate material, wherein the porosity of the particulate material, i.e. sand, is measured by forming a bed of sand and determining the force required to draw a plate out of the bed. As with the references noted above, the system is similarly believed to be limited to the testing of discrete samples.

U.S. Pat. Nos. 6,367,336, 4,535,915 and 4,069,709 disclose systems that employ a movable element that is deflected by a moving steam of material. The noted prior art references all measure the force imparted by the sample to quantify the rate of delivery. However, the disclosed systems are not configured to characterize the rheological properties of the material.

There are thus several perceived drawbacks and disadvantages associated with prior art methods and systems for measuring the rheological characteristics of powders, particularly particulate or powdered pharmaceutical compositions.

A significant perceived drawback is that none of the noted prior art systems are designed or configured to assess the rheological characteristics of a particulate or powdered pharmaceutical composition in real-time to ensure reproducibility, dose precision and optimum delivery properties.

It would accordingly be desirable to provide an improved method and system for characterizing the rheological characteristics of a dry powder, particularly a particulate pharmaceutical composition.

### SUMMARY OF THE INVENTION

In accordance with the above objects and those that will be mentioned and will become apparent below, in one embodiment of the invention, the system for determining a rheological property of a powdered material generally includes (i) a powder interacting member that is adapted to be disposed in a moving quantity of the powdered material, the powder interacting member having a shear/impact ratio in the range of 1.0-6.0, and (ii) force monitoring means adapted to be in communication with the powder interacting member for measuring the force imparted on the interacting member by the moving powdered material, the force monitoring means being further adapted to generate at least one signal representative of the rheological property of the powdered material when a force is imparted on the interacting member by the moving powdered material.

In another embodiment of the invention, the system for determining a rheological property of a powdered material generally includes (i) a powder interacting member that is adapted to be disposed in a moving quantity of the powdered material, and (ii) electrical monitoring means adapted to interact with the powder interacting member and determine at least one electrical property of the interacting member representing at least one rheological property of the powdered material when the interacting member is disposed in the moving quantity of the powdered material.

### BRIEF DESCRIPTION OF THE DRAWINGS

Further features and advantages will become apparent from the following and more particular description of various embodiments of the invention, as illustrated in the accompanying drawings, and in which like referenced characters generally refer to the same parts or elements throughout the views, and in which:

FIG. 1 is a schematic view of one embodiment of a system for characterizing rheological properties of a particulate or powdered pharmaceutical composition, according to the invention;

FIGS. 2-6A are perspective views of various embodiments of powder interacting members that are adapted to characterize rheological properties of a particulate or powdered pharmaceutical composition, according to the invention;

FIG. 6B is a bottom plane view of the powder interacting member shown in FIG. 6A, according to the invention;

FIG. 7A is a perspective view of yet another embodiment of a powder interacting member, according to the invention;

FIG. 7B is a perspective view of one embodiment of a base for the powder interacting member shown in FIG. 7A;

FIG. 8 is a graphical illustration showing the relationship of measured force to Carr's compressibility index for a first embodiment of an interacting member having a 10° angle of incidence, according to the invention;

FIG. 9 is a graphical illustration showing the relationship of measured force to Carr's compressibility index for the first embodiment of an interacting member having a 30° angle of incidence, according to the invention;

FIG. 10 is a graphical illustration showing the relationship of measured force to powder velocity for the first embodiment of an interacting member having a 10° angle of incidence, according to the invention;

FIG. 11 is a graphical illustration showing the relationship of measured force to powder velocity for the first embodiment of an interacting member having a 30° angle of incidence, according to the invention;

FIG. 12 is a graphical illustration showing the relationship of measured force to Carr's compressibility index for various powder interacting member designs, according to the invention;

FIG. 13 is a graphical illustration showing the relationship of measured force to flow function (FFc) for various powder interacting member designs, according to the invention;

FIG. 14 is a graphical illustration showing the relationship of measured force to bulk density for various powder interacting member designs, according to the invention

FIG. 15 is a graphical illustration of the multivariate relationship for various powder interacting member designs, according to the invention; and

FIG. 16 is graphical illustration showing the relationship of capacitance to bulk density for the powder interacting member shown in FIGS. 7A and 7B, according to the invention.

### DETAILED DESCRIPTION OF THE INVENTION

Before describing the present invention in detail, it is to be understood that this invention is not limited to particularly exemplified materials, methods or structures as such may, of course, vary. Thus, although a number of materials and methods similar or equivalent to those described herein can be used in the practice of the present invention, the preferred materials and methods are described herein.

It is also to be understood that the terminology used herein is for the purpose of describing particular embodiments of the invention only and is not intended to be limiting.

Unless defined otherwise, all technical and scientific terms used herein have the same meaning as commonly understood by one having ordinary skill in the art to which the invention pertains.

Further, all publications, patents and patent applications cited herein, whether supra or infra, are hereby incorporated by reference in their entirety.

Finally, as used in this specification and the appended claims, the singular forms “a”, “an”, “one” and “the” include plural referents unless the content clearly dictates otherwise.

### Definitions

The term “powder”, as used herein, is meant to mean and include any particulate, granular, ground, pulverized or otherwise finely divided solid particles of a material.

The term “powder” thus includes particulate or powdered pharmaceutical compositions.

The term “rheology”, as used herein, is meant to mean the ability of a material to flow or deform in response to various forces, and includes the material's viscosity, flowability and other related physical characteristics.

The term “flowability”, as used herein, is meant to mean and include the ability of a material to move smoothly from one location to another without excessive force, particularly with regard to a powder.

The term “Can's compressibility index” (or “CCI” or “CC %”), as used herein, is meant to mean a value derived by subtracting a powder's bulk density from its compacted density, dividing by its compacted density and multiplying by 100. The compacted density can be obtained by repeatedly tapping the sample to allow air to escape and cause the powder to settle.

The term “flow function” (or “FFc”), as used herein, is meant to mean the ratio of the consolidation stress σ₁ to the unconfined yield strength σ_{c}, i.e. FFc=σ_{c}/σ₁. As such, this characteristic provides a desirable measurement of a powder's flowability and cohesivity.

The term “Hausner ratio”, as used herein, is meant to mean a value derived by dividing a powder's compacted density by its bulk density.

The term “cohesion strength”, as used herein, is meant to mean the tendency of the individual particles of a powder to segregate, aggregate or otherwise interact with each other and resist free movement. Cohesion strength is often expressed as function of the consolidating pressure that forms the interactions, and the relationship is known as a “flow function.” Cohesion strength can be measured by determining the shear force necessary to disrupt the interactions.

The term “viscosity”, as used herein, is meant to mean the thickness or resistance to flow of a given material, particularly with regard to a powder. Viscosity is defined as the ratio of the shear stress to the shear rate. A material that exhibits Newtonian behavior is one for which the viscosity remains constant for any given shear rate.

Conversely, a material exhibits non-Newtonian behavior if the viscosity changes as the shear rate changes.

The term “viscoelasticity”, as used herein, is meant to mean a material's response to stress resulting in a combination of plastic deformation and elastic deformation over time.

The term “dilatant”, as used herein, is meant to mean and include materials that increase in viscosity with increasing shear rate.

The term “pseudoplastic”, as used herein, is meant to mean and include materials that decrease in viscosity with increasing shear rate.

The term “plastic”, as used herein, is meant to mean and include a material that can withstand a given amount of stress before it begins to flow.

The terms “yield stress” and “yield value”, as used herein, are meant to mean the amount of stress required to cause a plastic material to flow.

The term “thixotropic”, as used herein, is meant to mean and include a material that exhibits a viscosity that decreases over time.

The term “rheopectic”, as used herein, is meant to mean and include a material that exhibits a viscosity that increases over time.

The term “tensile strength”, as used herein, is meant to mean the resistance of a material to fracture failure under an applied stretching load.

The term “in-line”, as used herein, is meant to mean and include a system that can be integrated into a manufacturing process, allowing measurements of a powder's rheological characteristics to be taken while the manufacturing process is occurring.

The term “real-time”, as used herein, is meant to mean and include continuous monitoring and/or assessment during a manufacturing process to provide concurrent measurements of a powder's rheological characteristics.

The term “pharmaceutical composition”, as used herein, is meant to mean and include any compound or composition of matter or combination of constituents, which, when administered to an organism (human or animal) induces a desired pharmacologic and/or physiologic effect by local and/or systemic action. The term therefore encompasses substances traditionally regarded as actives, drugs and bioactive agents, as well as biopharmaceuticals (e.g., peptides, hormones, nucleic acids, gene constructs, etc.), including, but not limited to, analgesics, e.g., codeine, dihydromorphine, ergotamine, fentanyl or morphine; anginal preparations, e.g., diltiazem, ketotifen or nedocromil (e.g., as the sodium salt); beta agonists (e.g., long-acting beta agonists); antihistamines, e.g., methapyrilene; anti-inflammatories and anti-inflammatory steroids, e.g., cromoglicate (e.g. as the sodium salt), salbutamol (e.g. as the free base or the sulphate salt), salmeterol (e.g. as the xinafoate salt), bitolterol, formoterol (e.g. as the fumarate salt), terbutaline (e.g. as the sulphate salt), 3-(4-{[6-({(2R)-2-hydroxy-2-[4-hydroxy-3-(hydroxymethyl)phenyl]ethyl}amino)hexyl]oxy}butyl)benzenesulfonamide, 3-(3-{[7-({(2R)-2-hydroxy-2-[4-hydroxy-3-(hydroxymethyl)phenyl]ethyl}amino)heptyl]oxy}propyl)benzenesulfonamide, 4-{(1R)-2-[(6-{2-[(2,6-dichlorobenzyl)oxy]ethoxy}hexyl)amino]-1-hydroxyethyl}-2-(hydroxymethyl)phenol, 2-hydroxy-5-((1R)-1-hydroxy-2-{[2-(4-{[(2R)-2-hydroxy-2-phenylethyl]amino}phenyl)ethyl]amino}ethyl)phenylformamide, 8-hydroxy-5-{(1R)-1-hydroxy-2-[(2-{4-[(6-methoxy-1,1′-biphenyl-3-yl)amino phenyl}ethyl)amino]ethyl}quinolin-2(1H)-one, reproterol (e.g. as the hydrochloride salt), a beclomethasone ester (e.g. the dipropionate), a fluticasone ester (e.g. the propionate), a mometasone ester (e.g., the furoate), budesonide, dexamethasone, flunisolide, triamcinolone, tripredane, (22R)-6α.,9α-difluoro-11β,21-dihydroxy-16α,17α-propylmethylenedioxy-4-pregnen-3,20-dione; anti-infectives (e.g., cephalosporins, penicillins, streptomycin, sulphonamides, tetracyclines and pentamidine); bronchodilators, e.g., 3-(4-{[6-({(2R)-2-hydroxy-2-[4-hydroxy-3-(hydroxymethyl)phenyl]ethyl}amino)hexyljoxy}butyl)benzenesulfonamide, 3-(3-{[7-({(2R)-2-hydroxy-2-[4-hydroxy-3-(hydroxymethyl)phenyl]ethyl}amino)heptyl]oxy}propyl)benzenesulfonamide, 4-{(1i?)-2-[(6-{2-[(2,6-dichlorobenzyl)oxy]ethoxy}hexyl)amino]-1-hydroxyethyl}-2-(hydroxymethyl)phenol, 2-hydroxy-5-((IR)-1-hydroxy-2-{[2-(4-{[(2R)-2-hydroxy-2-phenylethyl]amino}phenyl)ethyl]amino}ethyl)phenylformamide, 8-hydroxy-5-{(1R)-1-hydroxy-2-[(2-{4-[(6-methoxy-1,1′-biphenyl-3-yl)amino]phenyl}ethyl)amino]ethyl}quinolin-2(1H)-one, albuterol (e.g., as free base or sulphate), salmeterol (e.g., as xinafoate), ephedrine, adrenaline, fenoterol (e.g., as hydrobromide), formoterol (e.g. as fumarate), isoprenaline, metaproterenol, phenylephrine, phenylpropanolamine, pirbuterol (e.g., as acetate), reproterol (e.g., as hydrochloride), rimiterol, terbutaline (e.g., as sulphate), isoetharine, tulobuterol or 4-hydroxy-7-[2-[[2-[[3-(2-phenylethoxy)propyl]sulfonyl]ethyl]amino]ethyl-2(3H)-benzothiazolone; adenosine 2a agonists, e.g., 2R,3R,4S,5R)-2-[6-Amino-2-(1S-hydroxymethyl-2-phenyl-ethylamino)-purin-9-yl]-5-(2-ethyl-2H-tetrazol-5-yl)-tetrahydro-furan-3,4-diol (e.g., as maleate); α₄ integrin inhibitors e.g. (2S)-3-[4-({[4-(aminocarbonyl)-1-piperidinyljcarbonyl}oxy)phenyl]-2-[((2S)-4-methyl-2-{[2-(2-methylphenoxy)acetyljamino}pentanoyl)amino]propanoic acid (e.g., as free acid or potassium salt), diuretics, e.g., amiloride; anticholinergics, e.g., ipratropium (e.g. as bromide), tiotropium, atropine or oxitropium; hormones, e.g., cortisone, hydrocortisone or prednisolone; corticosteroids, e.g., (6α,11β,16α,17α)-6,9-difluoro-17-{[(fluoromethyl)thio]carboπyl}-11-hydroxy-16-methyl-3-oxoandrosta-1,4-dien-17-yl 2-furoate, (6α,11β,16α,17α)-6,9-difluoro-17-{[(fluoromethyl)triio]carbonyl}-11-hydroxy-16-methyl-3-oxoandrosta-1,4-dien-17-yl 4-methyl-1,3-thiazole-5-carboxylate, xanthines, e.g., aminophylline, choline theophyllinate, lysine theophyllinate or theophylline; therapeutic proteins and peptides, e.g., insulin or glucagon.

In addition to those stated above, it will be clear to a person skilled in the art that, where appropriate, the noted pharmaceutical compositions or medicaments can be used in the form of salts, (e.g., as alkali metal or amine salts or as acid addition salts) or as esters (e.g., lower alkyl esters) or as solvates (e.g., hydrates) to optimize the activity and/or stability of the medicament. It will be further clear to a person skilled in the art that where appropriate, the pharmaceutical compositions can be used in the form of a pure isomer, for example, R-salbutamol or RR-formoterol.

Further pharmaceutical compositions include those useful in erectile dysfunction treatment (e.g., PDE-V inhibitors, such as vardenafil hydrochloride, along with alprostadil and sildenafil citrate).

The term “pharmaceutical composition” also encompasses formulations containing combinations of actives, including, but not limited to, beta-agonists, including any of these described herein, such as, without limitation, salbutamol (e.g., as the free base or the sulphate salt), salmeterol (e.g., as the xinafoate salt), budesonide, formoterol (e.g., as the fumarate salt) in combination with an anti-inflammatory steroid including any of those described herein, such as, without limitation, a beclomethasone ester (e.g., the dipropionate) or a fluticasone ester (e.g., the propionate), budesonide, rosiglitazone, ramipril and meformin.

The “pharmaceutical compositions”, alone or in combination with other actives (or agents), can include one or more added materials or constituents, such as carriers, vehicles, and/or excipients. “Carriers,” “vehicles” and “excipients” generally refer to substantially inert materials that are nontoxic and do not interact with other components of the composition in a deleterious manner. These materials can be used to increase the amount of solids in particulate pharmaceutical compositions. Examples of suitable carriers include water, fluorocarbons, silicone, gelatin, waxes, and like materials. Examples of normally employed “excipients,” include pharmaceutical grades of carbohydrates, including monosaccharides, disaccharides, cyclodextrins, and polysaccharides (e.g., dextrose, sucrose, lactose, raffinose, mannitol, sorbitol, inositol, dextrins, and maltodextrins); starch; cellulose; salts (e.g., sodium or calcium phosphates, calcium sulfate, magnesium sulfate); citric acid; tartaric acid; glycine; low, medium or high molecular weight polyethylene glycols (PEG's); pluronics; surfactants; and combinations thereof. Other possible added materials include stearates (e.g., magnesium stearate, calcium stearate).

One additional component that can be employed in a pharmaceutical composition is one or more “derivatized carbohydrates”. The term “derivatized carbohydrates” is used herein to describe a class of molecules in which at least one hydroxyl group of the carbohydrate group is substituted with a hydrophobic moiety via either ester or ethers linkages. All isomers (both pure and mixtures thereof) are included within the scope of this term. Mixtures of chemically distinct derivatised carbohydrates can also be utilized. Suitably, the hydroxyl groups of the carbohydrate can be substituted by a straight or branched hydrocarbon chain comprising up to 20 carbon atoms, more typically up to 6 carbon atoms. The derivatized carbohydrates can be formed by derivitisation of monosaccharides (e.g. mannitol, fructose and glucose) or of disaccharides (e.g. maltose, trehalose, cellobiose, lactose and sucrose). Derivatized carbohydrates are either commercially available or can be prepared according to procedures readily apparent to those skilled in the art.

Non limiting examples of derivatized carbohydrates include, without limitation, cellobiose octaacetate, sucrose octaacetate, lactose octaacetate, glucose pentaacetate, mannitol hexaacetate and trehalose octaacetate. Further suitable examples include those specifically disclosed in patent application WO 99/33853 (Quadrant Holdings), particularly trehalose diisobutyrate hexaacetate. A particularly preferred derivatized carbohydrate is α-D cellobiose octaacetate. Typically, the aerodynamic size of the derivatized carbohydrates is in the range of approximately 1-50 μm, and more particularly, in the range of approximately 1-20 μm.

The derivatized carbohydrates for use in the preparation of compositions referenced herein are typically micronized, but controlled precipitation, supercritical fluid methodology and spray drying techniques familiar to those skilled in the art can also be utilized. Suitably, the derivatised carbohydrate is present in a concentration in the range of approximately 0.01-50% by weight of the total composition, preferably 1-20 wt. %. Other carriers such as, for example, magnesium stearate, can also be used in the formulations.

The “pharmaceutical compositions” referred to herein and employed within the scope of the invention are preferably in powdered form. The terms powdered pharmaceutical compositions and powdered pharmaceutical formulations are used interchangeably herein and are often referred to collectively as “powders”. The term “powder”, as used herein, also includes single component powders, e.g., neat actives, lactose, etc.

By the term “pharmaceutical delivery device”, as used herein, it is meant to mean a device that is adapted to administer a controlled amount of a composition to a patient, including, but not limited to, the Diskus® device disclosed in U.S. Pat. Nos. D342,994; 5,590,654, 5,860,419; 5,837,630, 6,032,666; 6,378,519; 6,536,427 and 6,792,945; the Diskhaler™ device disclosed in U.S. Pat. Nos. D299,066; 4,627,432 and 4,811,731; the Rotodisc™ device disclosed in U.S. Pat No. 4,778,054 and the medicament delivery device disclosed in WO 03/061743 and WO 03/061744; all of which are incorporated by reference in their entirety. Other illustrative devices include the Cyclohaler™ device by Norvartis; the Turbohaler™ device by Astra Zeneca; the Twisthaler™ device by Scheling Plough; the Handihaler™ device by Boehringer Engelheim and the Airmax™ device by Baker-Norton.

As discussed above, the reproducible and precise filling of a DPI with a given dose of a particulate or powdered pharmaceutical composition typically requires accurate characterization of the powdered composition's rheological properties, such as its viscosity, flowability, Carr's compressibility index or flow function.

By way of example, during the manufacture of a DPI the powdered pharmaceutical composition is loaded into a formed blister pack. The automated filling process is typically either immersion or compression based. However, regardless of the method used, the rheology of the powdered pharmaceutical composition must be well characterized to properly load the DPI with a precise amount of the composition.

In accordance with one embodiment of the invention, the rheology of the powder, e.g., pharmaceutical composition, is continuously monitored during manufacture or processing. The continuous monitoring of the composition's rheology provides quality assurance means to ensure that precise amounts of the active are being provided.

In a further embodiment of the invention, information relating to the rheology of a powder (or powdered pharmaceutical composition), which is determined by the systems of the invention, i.e. rheometers, is used to adjust the variables of the manufacturing process to achieve greater control over the resulting product. In another embodiment, a feedback control system, which is based on the monitored rheology of a powdered pharmaceutical composition, varies one or more parameters of the manufacturing process to ensure that the desired amount of powdered pharmaceutical composition and, hence, active is being provided.

As noted above, the ability of a given particulate or powder to flow is multidimensional and often depends upon many complex characteristics of the powder itself Flowability is thus the result of the combination of material physical properties that affect a powder's flow. Examples of these physical properties include density, compressibility, cohesive strength and wall friction. As one having skill in the art will appreciate, and without being bound by any theory, it is believed that these flow properties arise from the collective forces acting on the individual particles, including van der Walls, electrostatic, surface tension, interlocking, friction and others.

For example, two commonly used measures reflecting the relative importance of interactions between particles in a powder are Carr's compressibility index (referred to herein as “CCI” or “CC %”) and the Hausner ratio. Each measure compares a powder's bulk density to its compacted density. These measures are useful in predicting a powder's flowability, since free-flowing powders tend to have less difference between their bulk and compacted densities. Conversely, powders that exhibit poor flowability typically have greater disparity between their bulk and compacted densities.

Rheological characteristics of a powder and/or powdered pharmaceutical composition can also be expressed as the flow function, “FFc”, which is defined as the consolidation stress σ₁ to the unconfined yield strength σ_{c}, i.e.

$$FFc = \frac{{σ}_{c}}{{σ}_{1}} \qquad ( 1 )$$

As will be appreciated by one having skill in the art, the larger the flow function “FFc”, the better a bulk solid flows. Thus, the following ranking is often employed:

| | |
|---|---|
| FFc < 1 | not flowing |
| 1 < FFc < 2 | very cohesive to non-flowing |
| 2 < FFc < 4 | cohesive |
| 4 < FFc < 10 | easy flowing |
| 10 < FFc | free flowing |

FFc accordingly provides an indication of a powdered composition's flowability and cohesivity.

Another property associated with a powder's flowability is its yield stress. Relating yield stress to normal stress has been found to give an estimation of a powder's ability to flow. It is further believed that flowability can also be described by the relationship between consolidation stress, tensile strength, and free volume. Generally, a powder's tensile strength will directly affect the amount of stress necessary to fluidize the powder.

As described above, one aspect of the current invention is to provide a system and method for measuring these rheological characteristics during the manufacture of a DPI, preferably to improve process control and quality monitoring. In one embodiment of the invention, the force transmitted by a quantity of moving powdered material, e.g., pharmaceutical composition, to a member designed to interact with the powdered material is directly measured online and in real-time during the manufacturing process. Establishing the force measurement's relation to fill performance enables the use of a controlled process via a closed loop feedback.

Referring now to FIG. 1, there is shown one embodiment of a system, i.e. rheometer, 10 of the invention that can be effectively employed to determine one or more rheological properties or characteristics of a powdered material. As illustrated in FIG. 1, rheometer 10 includes a powder interacting member 12 engaged to a shaft 14 that is in communication with or attached to force monitoring means (designated generally “20”). According to the invention, the force monitoring means 20 in the illustrated embodiment can comprise mechanical means, such as a mechanical torque or force gage, electro-mechanical means, such as a load cell or strain gage transducer, or a combination thereof. In another embodiment of the invention, discussed herein, the system includes electrical monitoring means.

According to the invention, the powder interacting member 12 is disposed within a flow of powdered material 11, whereby the movement of the powdered material imparts a force to the interacting member 12 and, hence, shaft 14. The force monitoring means 20, which interacts with shaft 14 proximate pivot point 16, measures the force imparted by the flow of powdered material upon the interacting member 12 and provides at least one signal representing at least one rheological property of the powered material.

In one embodiment, the force monitoring means 20 comprises a load cell that generates a variable electrical signal that is proportional to the force imparted through member 12 to shaft 14. Load cell technology is presently preferred since the load cell 20 can be miniaturized for integration with a compression filling process. In one embodiment, the load cell 20 comprises a 20N load cell that generates a 0-20 mV signal representing the force transmitted to the shaft 14.

Referring back to FIG. 1, in one embodiment of the invention, powder interacting member 12 generally has a three-sided pyramidal shape that tapers to a leading point 18; the tapered region forming an incident angle α. In one embodiment of the invention, the incident angle α is preferably in the range of approximately 1-90°. In another embodiment, the incident angle α is in the range of approximately 10-30°.

As illustrated in FIG. 1, the top faces 19, 20 of the pyramidal shaped member 12 form an angle β with respect to shaft 14. In one embodiment of the invention, angle β is in the range of approximately 1-180°. In another embodiment, angle β is in the range of approximately 90-179°. In at least one embodiment, the overall length L1 of the powder interacting member 12 is in the range of approximately 10-100 mm.

According to the invention, incident angle α represents the degree of deflection of a powdered material that is flowing tangentially to the powder interacting member 12. As discussed in detail herein, angle α can be chosen to emphasize the contribution of shear or impact forces as desired for a given application.

For example, the relative effects of shear and impact can be compared for a powder interacting member 12 having an angle α of 10° or 30°. Calculation of the reflex angle from the tangential flow of the powdered material is capable of providing an estimate of the shear/impact ratio according to the formula:

Shear/impact ratio=(tan α)⁻¹ (2)

Analysis of this relationship indicates how the shear (frictional) and impact (momentum) forces contribute to the force imparted to shaft 14 for a powder interacting member 12 having a given angle α.

In view of equation (2), it is apparent that when α=90° the impact force is the overriding effect and the shear force approaches zero. Correspondingly, when α=0° the shear force is the overriding effect and the impact force approaches zero. Hence, this formula can be used to define which angle will give the most effective geometry in order to characterize the property being measured by rheometer 10.

A powder interacting member, such as interacting member 12, having an angle α equal to approximately 10° will thus experience a force corresponding to:

Shear/impact ratio=(tan 10°)⁻¹=5.67 (3)

Similarly, a powder interacting member having an angle α equal to approximately 30° will experience a force corresponding to:

Shear/impact ratio=(tan 30°)⁻¹=1.73 (3)

A comparison of equations (3) and (4) above indicates that a powder interacting member having an angle of incidence equal to approximately 10° provides a force measurement that is influenced by shear force 3.2× more than impact force when compared to a powder interacting member having an angle of incidence equal to approximately 30°. Thus, in accordance with one embodiment of the invention, selective powder interacting members of the invention, including interacting member 12, are configured to have a shear/impact ratio in the range of approximately 1-600. In another embodiment, the interacting member 12 has a shear/impact ratio in the range of approximately 1-6. In yet another embodiment, the interacting member 12 has a shear/impact ratio in the range of approximately 1.7-5.7.

According to the invention, various alternative powder interacting member designs can be employed within the scope of the invention. Several alterative designs are shown in the embodiments illustrated in FIGS. 2-5, 6A-6B and 7A-7B.

Referring first to FIG. 2, there is shown a perspective view of another embodiment of a powder interacting member 22 of the invention. As illustrated in FIG. 2, powder interacting member 22 generally comprises a spherical portion 24 attached to shaft 14.

In one embodiment, the diameter of the powder interacting member 22 is in the range of approximately 2-100 mm. In another embodiment, the diameter of the powder interacting member 22 is in the range of approximately 2-50 mm.

In one embodiment of the invention, the powder interacting member 22 is configured to have a shear/impact ratio in the range of approximately 1-600. In another embodiment, interacting member 22 has a shear/impact ratio in the range of approximately 1.7-5.7.

As discussed below, the force transmitted to the powder interacting member 22 by a moving powdered material or composition exhibits a generally linear relationship to Carr's compressibility index (CCI).

Referring now to FIG. 3, there is shown a perspective view of another embodiment of a powder interacting member 26 of the invention. As illustrated in FIG. 3, the powder interacting member 26 has a generally conical leading portion 28 that transitions to a constant diameter portion 30.

In one embodiment of the invention, the conical portion 28 has a length L2 in the range of approximately 10-100 mm with a cone angle Ø in the range of approximately 0-45°. Further, constant diameter portion 30 has a length L3 in the range of approximately 5-80 mm with a diameter in the range of approximately 2-50 mm.

In one embodiment of the invention, the powder interacting member 26 is configured to have a shear/impact ratio in the range of approximately 1-600. In another embodiment, interacting member 26 has a shear/impact ratio in the range of approximately 1.7-5.7.

As discussed below, the force transmitted to the powder interacting member 26 by a moving powdered material exhibits a generally linear relationship to CCI. In one embodiment of the invention, a powder interacting member having a design corresponding to powder interacting member 26 is used to determine CCI of a powdered pharmaceutical composition.

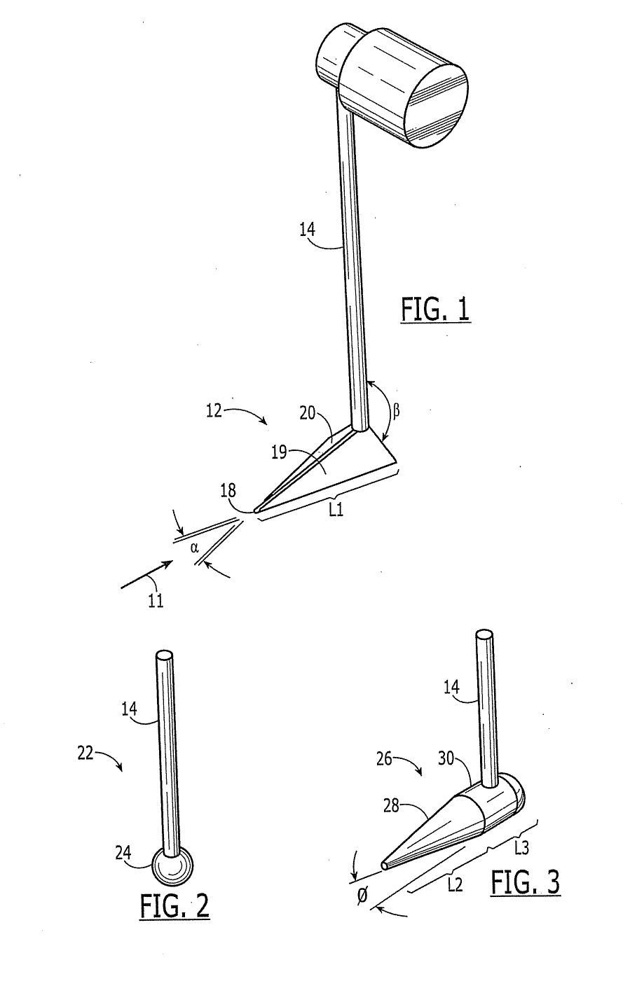

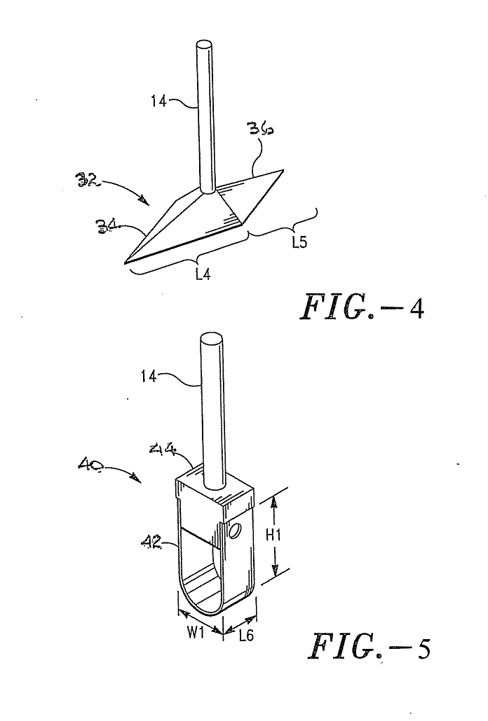

Referring now to FIG. 4, there is shown yet another embodiment of a powder interacting member 32 of the invention. As illustrated in FIG. 4, the powder interacting member 32 has a leading portion 34 positioned ahead of the attachment of shaft 14 and a trailing portion 36 positioned behind the attachment of shaft 14. Generally, leading portion 46 and trailing portion 50 have configurations (and dimensions) similar to the three-sided pyramidal shaped powder interacting member 12 shown in FIG. 1.

In one embodiment of the invention, leading portion 34 has a length L4 in the range of approximately 10-100 mm and trailing portion 36 has a length L5 in the range of approximately 10-100 mm.

In one embodiment of the invention, the powder interacting member 32 is similarly configured to have a shear/impact ratio in the range of approximately 1-600. In another embodiment, interacting member 32 has a shear/impact ratio in the range of approximately 1.7-5.7.

Referring now to FIG. 5, there is shown a perspective view of a further powder interacting member 40 of the invention. As illustrated in FIG. 5, the powder interacting member 40 includes a U-shaped portion 42 that is secured to a top portion 44, which is in turn engaged to shaft 14.

In one embodiment of the invention, the U-shaped portion 42 has a height H1 in the range of approximately 5-100 mm, a length L6 in the range of approximately 2-50 mm and width W1 in the range of approximately 2-50 mm.

In one embodiment of the invention, the powder interacting member 40 is configured to have a shear/impact ratio in the range of approximately 1-600. In another embodiment, interacting member 40 has a shear/impact ratio in the range of approximately 1.7-5.7.

As discussed below, the force transmitted to interacting member 40 by a moving powdered material exhibits a generally linear relationship to flow function (FFc) and bulk density. In one embodiment of the invention, an interacting member having a design corresponding to powder interacting member 40 is accordingly preferably employed to determine FFc and/or bulk density of a powdered pharmaceutical composition.

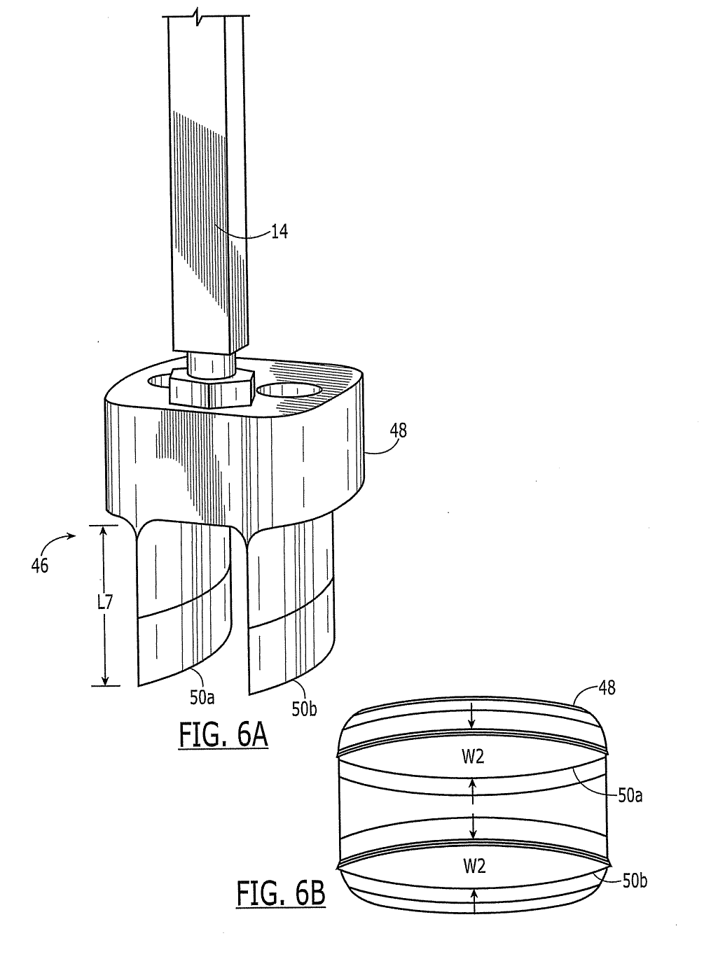

Referring now to FIG. 6A, there is shown a perspective view of yet another powder interacting member 46 of the invention. As illustrated in FIG. 6A, the powder interacting member 46 includes a base 48 that is engagable to shaft 14. The base 48 includes at least one, preferably, two planar, substantially parallel extensions or plates 50a, 50b, whereby when the base 48 is engaged to the shaft 14 the plates 50a, 50b are disposed in a substantially vertical orientation.

Referring to FIG. 6B, in one embodiment of the invention, the plates 50a, 50b have an elliptical cross section with a width W2 (proximate the center) in the range of approximately 1-20 mm. In one embodiment, the plates 50a, 50b have a length in the range of approximately 5-100 mm. In another embodiment, the plates 50a, 50b have a length in the range of approximately 10-50 mm.

In one embodiment of the invention, the powder interacting member 46 is configured to have a shear/impact ratio in the range of approximately 1-600. In another embodiment, interacting member 46 has a shear/impact ratio in the range of approximately 1.5 to 6.0, and in yet another embodiment from 1.7-5.7.

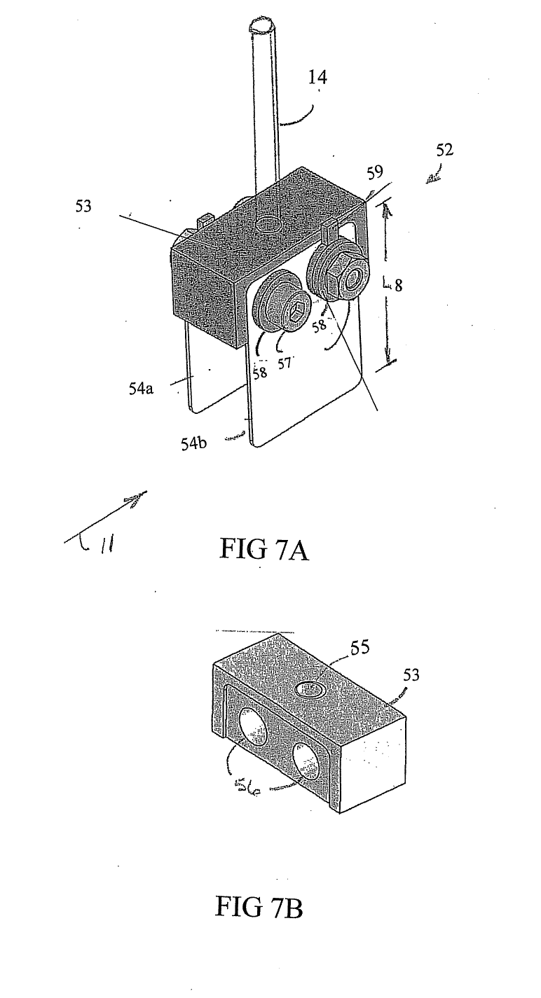

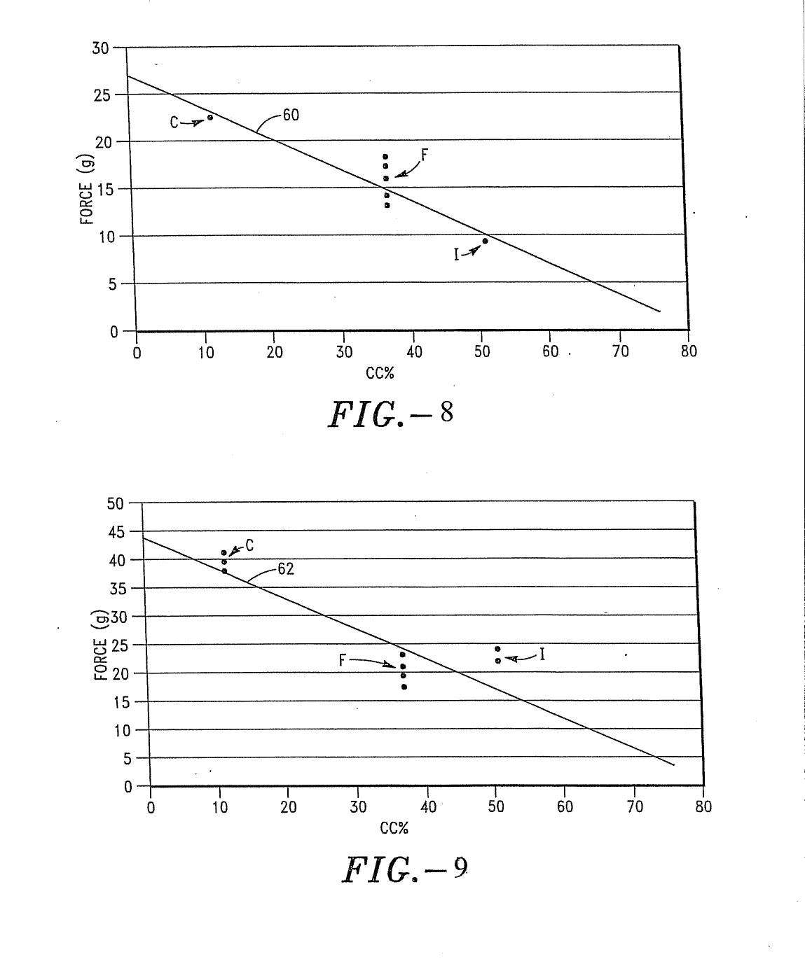

In another embodiment of the invention, shown in FIGS. 7A and 7B and discussed in detail below, the powder interacting member 52 similarly includes a base 53 and two substantially planar plates 54a, 54b. In the noted embodiment, the plates 54a, 54b have substantially uniform cross-sections, although other configurations may be employed.

According to the invention, interacting members 12, 22, 26, 32, 40, 46 and shaft 14 can comprise various high strength, preferably light weight materials, including, without limitation, stainless steel and high strength polymeric materials. In one embodiment of the invention, the interacting members 12, 22, 26, 32, 40 and 46 comprise stainless steel.

In some embodiments of the invention, shaft 14 comprises a high strength, non-conductive material, such as a high density polymeric material and nylon.

Although interacting members 12, 22, 26, 32, 40 and 46 are described above as being engaged to shaft 14, as will readily apparent to one having ordinary skill in the art, the shaft 14 can also be an integral extension of any of the members 12, 22, 26, 32, 40, 46. The shaft 14 can also be a separate member or an integral component of a force monitoring means of the invention.

As will also be readily apparent to one having ordinary skill in the art, the configurations of each of the interacting members 12, 22, 26, 32, 40, 46 can be varied to adjust the ratio of shear force to impact force being measured. In this manner, the most effective geometry can be used to characterize the property being measured by the systems of the invention.

In accordance with one embodiment of the invention, the system for determining a rheological property of a powdered material generally includes (i) a powder interacting member that is adapted to be disposed in a moving quantity of the powdered material, the powder interacting member having a shear/impact ratio in the range of 1.0-6.0, and (ii) force monitoring means adapted to be in communication with the powder interacting member for measuring the force imparted on the powder interacting member by the moving powdered material, the force monitoring means being further adapted to generate at least one signal representative of the rheological property of the powdered material when a force is imparted on the interacting member by the moving powdered material.

In one embodiment of the invention, the rheological property is selected from the group consisting of viscosity, flowability and Carr's compressibility index (CC %).

In one embodiment of the invention, the force monitoring means comprises mechanical force monitoring means. In one embodiment, the mechanical force monitoring means comprises a mechanical force gage. In another embodiment, the mechanical force monitoring means comprises a mechanical torque gage.

In one embodiment of the invention, the force monitoring means comprises electro-mechanical force monitoring means. In one embodiment, the electro-mechanical force monitoring means includes a load cell sensor system. In another embodiment, the electro-mechanical force monitoring means includes a strain gage sensor system.

In one embodiment, the electro-mechanical force monitoring means includes a pivoting shaft secured to the powder interacting member and a force sensor, i.e. load cell, that is in communication with the pivoting shaft, the force sensor being adapted to generate at least one signal representative of the rheological property of the powdered material when the moving powdered material imparts a force to the powder interacting member and, hence, shaft.

In accordance with one embodiment of the invention, the method for determining a rheological property of a powdered material, thus comprises the steps of (i) providing a moving quantity of the powdered material, (ii) providing a rheometer having a powder interacting member and force monitoring means adapted to be in communication with the powder interacting member for measuring the force imparted on the interacting member by the moving powdered material, the force monitoring means being further adapted to generate at least one signal representative of the rheological property of the powdered material when a force is imparted on the interacting member by the moving powdered material, (iii) disposing the powder interacting member within the moving quantity of the powdered material, and (iv) detecting the signal generated by the force monitoring means.

In accordance with another embodiment of the invention, the system for determining a rheological property of a powdered material includes electrical monitoring means. According to the invention, the electrical monitoring means is adapted to interact with a powder interacting member and determine at least one electric property or characteristic associated with the powder interacting member that is representative of at least one rheological property of a powder. In one embodiment of the invention, discussed in detail below, the electrical monitoring means is adapted to measure the capacitance between two electrically conductive members of the interacting member.

Referring back to FIGS. 7A and 7B, there is shown one embodiment of a powder interacting member 52 that can be employed with the electrical monitoring means of the invention. As indicated above, the interacting member 52 includes a base 53 and two substantially planar plates 54a, 54b having substantially uniform cross-sections.

In one embodiment, the plates 54a, 54b have a length L8 in the range of 5-100 mm; in another embodiment, in the range of approximately 10-50 mm. In one embodiment, the plates 54a, 54b have a thickness in the range of approximately 0.1-5 mm; in another embodiment, in the range of approximately 0.25-0.75 mm. As illustrated in FIG. 7A, the plates 54a, 54b are preferably oriented parallel to the flow of the powder 11 and, in one embodiment of the invention, the distance between the plates 54a, 54b is preferably in the range of approximately 5-100 mm. In another embodiment, the distance between the plates 54a, 54b is in the range of approximately 5-20 mm. As discussed in detail below, the dimensions of the plates 54a, 54b and distance therebetween are critical factors in the capacitance measurements.

According to the invention, the plates 54a, 54b can comprise various high strength, conductive materials. In one embodiment of the invention, the plates 54a, 54b comprise stainless steel.

Preferably, the base 53 comprises a high strength, non-conductive material. In one embodiment of the invention, the base 53 comprises polyetheretherketone, ie PEEK.

In one embodiment of the invention, shaft 14 comprises a non-conductive material, such as a high density polymeric material or nylon.

As illustrated in FIG. 7B, the base 53 includes a mounting hole 55 adapted to receive shaft 14 and two plate mounting holes 56 adapted to receive mounting bolts 57 therethrough. Although not shown plates 54a, 54b similarly include mounting holes adapted to receive mounting bolts 57 therethrough.

According to the invention, the interacting member 52 further includes insulating washers 58 that are adapted to be disposed between the bolts 57 and plates 54a, 54b and at least one, preferably two electrical connectors 59.

As will be apparent to one having ordinary skill in the art, interacting member 46 (shown in FIG. 6A) can also be readily adapted (e.g., material, dimensions, spacing between plates 50a, 50b, etc) to be employed with the electrical monitoring means of the invention.

As is well known in the art, capacitance is typically defined as the property of an electric non-conductor that permits the storage of energy as a result of electric displacement when opposite surfaces of the non-conductor are maintained at a difference of potential. Capacitance is thus typically measured between to electrically conducting members, e.g., plates 54a, 54b.

As is also well known in the art, capacitance is a function of the dielectric properties (i.e. relative permittivity) of the material(s) between and around the conducting members or plates, the geometry of the plates and the distance between the plates.

For a standard parallel plate capacitor, where the plates are large in relation to the distance between them, the capacitance C is determined as follows:

$$C = \frac{{ɛ}_{0} {ɛ}_{r} A}{d} \qquad ( 5 )$$

where:

ε₀=the permittivity of free space, i.e. 8.854×10⁻¹² F/m;

εᵣ=the relative permittivity of the dielectric, which is 1 for a vacuum, but higher for most materials, e.g., mica, has a relative permittivity of approximately 6;

A=the surface area of each plate; and

d=the distance between the plates.

Applicants have found that a powder or powdered material, which consists of powder particles and air, has a relative permittivity (also known as “dielectric constant”) dependent on the ratio of the powder particles to air. This is because the relative permittivity of air is approximately 1, but that of the powder particles is higher. This means that the dielectric constant increases with powder density (for a given powdered material).

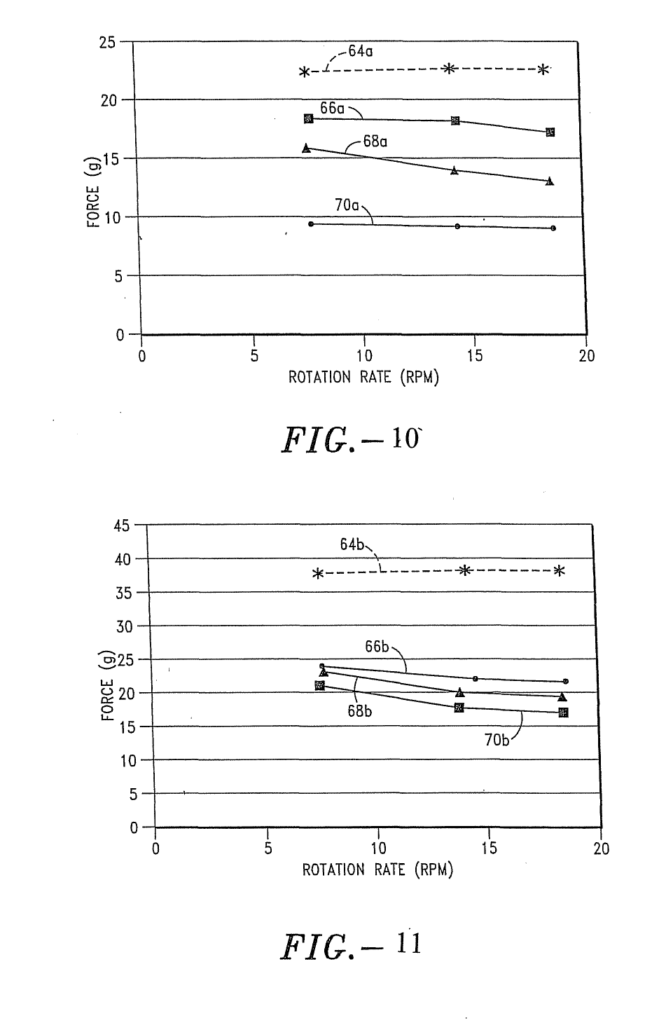

The capacitance, which is proportional to the dielectric constant, thus increases with powder density, which is graphically illustrated in FIG. 8 (discussed in detail below). This has also been shown for microcrystalline cellulose in a previous study by Ek, et al. in the Journal of Materials Science, vol. 32, pp. 4807-14 (1997).

The electrical monitoring means of the invention, i.e. measuring capacitance between two conducting members as a powdered material flows therethrough, thus provides effective means for determining at least one rheological property of the powdered material, including the flowability, viscosity and CC % thereof. According to the invention, the noted electrical monitoring means can be employed solely to determine a rheological property of a powdered material or in combination with the mechanical and/or electro-mechanical force monitoring means set forth above.

In accordance with one embodiment of the invention, the system for determining a rheological property of a powdered material generally includes (i) a powder interacting member that is adapted to be disposed in a moving quantity of the powdered material, and (ii) electrical monitoring means adapted to interact with the powder interacting member and determine at least one electrical property of the interacting member representing at least one rheological property of the powdered material when the interacting member is disposed in the moving powdered material.

In one embodiment of the invention, the rheological property is selected from the group consisting of viscosity, flowability and CC %.

In one embodiment of the invention, the powder interacting member includes two electrically conductive members and the electrical monitoring means is adapted to measure the capacitance between the two electrically conductive members when the electrically conductive members are disposed in the moving powdered material, the capacitance representing at least one rheological property of the powdered material.

In one embodiment of the invention, the system includes mechanical force monitoring means.

In one embodiment of the invention, the system includes electro-mechanical force monitoring means.

In accordance with one embodiment of the invention, the method for determining a rheological property of a powdered material, comprises the steps of (i) providing a moving quantity of the powdered material, (ii) providing a rheometer having a powder interacting member and electrical monitoring means adapted to interact with the powder interacting member and determine at least one electrical property of the interacting member representing at least one rheological property of the powdered material when the interacting member is disposed in the moving powdered material, (iii) disposing the powder interacting member in the moving powdered material, and (iv) measuring the electrical property.

In accordance with another embodiment of the invention, the method for determining a rheological property of a powdered material, comprises the steps of (i) providing a moving quantity of the powdered material, (ii) providing a rheometer having a powder interacting member, the interacting member having two electrically conductive members that are adapted to be disposed in a moving quantity of the powdered material, and electrical monitoring means adapted to measure the capacitance between the two electrically conductive members when the electrically conductive members are disposed in the moving powdered material, (iii) disposing the electrically conductive members in the moving powdered material, and (iv) measuring the capacitance between the two electrically conductive members, the capacitance representing at least one rheological property of the powdered material.

In one embodiment of the invention, the rheological property that is selected from the group consisting of viscosity, flowability and CC %.

### Examples

The following examples are provided to enable those skilled in the art to more clearly understand and practice the present invention. They should not be considered as limiting the scope of the invention, but merely as being illustrated as representative thereof.

In Example 1 below, three grades of lactose powder, i.e. coarse, intermediate and fine, and one interacting member design were analyzed. The design of the interacting member corresponded to the interacting member design shown in FIG. 1.

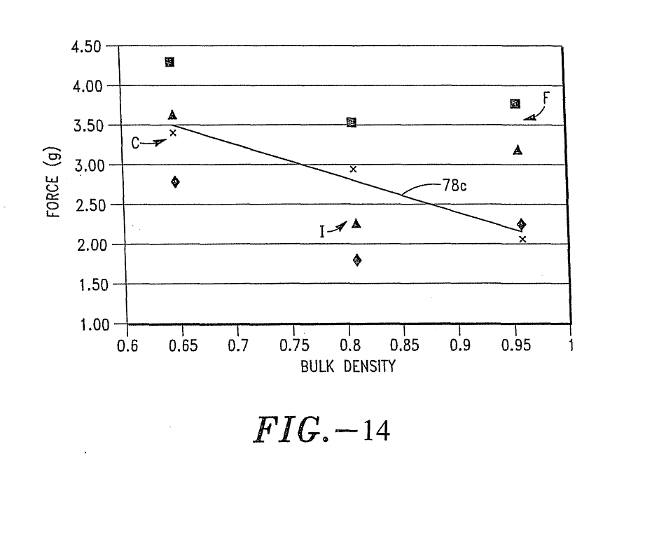

The data points shown in FIGS. 10 and 11 relating to the grades of lactose are identified as follows: coarse grade lactose (*); intermediated grade lactose (▪); and fine grade lactose (▴ and ).

In Example 2 below, three grades of lactose, i.e. coarse, intermediate and fine, and four interacting member designs were analyzed. Design 1 corresponded to the interacting member design shown in FIG. 1. Design 2 corresponded to the interacting member design shown in FIG. 3. Design 3 corresponded to the interacting member design shown in FIG. 2. Design 4 corresponded to the interacting member design shown in FIG. 5.

The data points shown in FIGS. 10-15 relating to the interacting member designs are identified as follows: design 1 (*); design 2 (▪); design 3 (▴); and design 4 (x).

### Example 1

To investigate the theoretical conclusions indicated by equations (2) and (3) above, two interacting members corresponding to interacting member 12 (shown in FIG. 1) and having incidence angles α of 10° and 30°, respectively, were constructed in 316 L Stainless steel. Three grades of lactose, having varying particle sizes (i.e., fine, intermediate and coarse), were used as the experimental substrate.

The bulk density of the lactose grades ranged from approximately 0.4 to 0.6 kg/m³, which represents the typical range used in most DPI formulations. It has been found that the compaction and Carr's compressibility index (designated “CCI” or “CC % herein) is a useful indicator of powder flowability. Therefore, the CCI of each lactose grade was calculated as well.

The noted interacting members were employed in rheometers (e.g. rheometer 10) of the invention. The rheometers were integrated into an immersion filler configured to load DPIs with a powdered pharmaceutical composition. The interacting members were disposed within a rotating hopper filled with the powdered composition. The speed of hopper rotation was varied to assess the effect of powder velocity on the rheological characterizations.

The force measurements, i.e. force(s) imparted on the interacting member by the flow of the lactose powder, obtained at various rotation speeds for each lactose grade with the 10° interacting member are provided in Table 1.

TABLE 1

| | Rotation | Initial | Tapped | | |
|---|---|---|---|---|---|
| Angle | Rate | Density | Density | CC | Force |
| (α) | (rpm) | (g/ml) | (g/ml) | % | (g) |
| 10° | 8 | 0.57 | 0.65 | 12 | 22.4 |
| 10° | 8 | 0.57 | 0.65 | 12 | 22.4 |
| 10° | 14 | 0.57 | 0.65 | 12 | 22.6 |
| 10° | 14 | 0.57 | 0.65 | 12 | 22.6 |
| 10° | 19 | 0.57 | 0.65 | 12 | 22.6 |
| 10° | 19 | 0.57 | 0.65 | 12 | 22.6 |
| 10° | 8 | 0.6 | 0.96 | 37 | 15.9 |
| 10° | 8 | 0.6 | 0.96 | 37 | 18.3 |
| 10° | 14 | 0.6 | 0.96 | 37 | 14.1 |
| 10° | 14 | 0.6 | 0.96 | 37 | 18.1 |
| 10° | 19 | 0.6 | 0.96 | 37 | 13.1 |
| 10° | 19 | 0.6 | 0.96 | 37 | 17.3 |
| 10° | 8 | 0.39 | 0.81 | 51 | 9.4 |
| 10° | 14 | 0.39 | 0.81 | 51 | 9.2 |
| 10° | 15 | 0.39 | 0.81 | 51 | 9.35 |
| 10° | 19 | 0.39 | 0.81 | 51 | 9.15 |
| 10° | 19 | 0.39 | 0.81 | 51 | 9.13 |
| 10° | 21 | 0.39 | 0.81 | 51 | 8.8 |

Table 2 provides the data corresponding to force measurements obtained at various rotation speeds for each lactose grade with the 30° interacting member.

TABLE 2

| | Rotation | Initial | Tapped | | |
|---|---|---|---|---|---|
| Angle | Rate | Density | Density | CC | Force |
| (α) | (rpm) | (g/ml) | (g/ml) | % | (g) |
| 30° | 8 | 0.57 | 0.65 | 12 | 38.0 |
| 30° | 14 | 0.57 | 0.65 | 12 | 38.4 |
| 30° | 19 | 0.57 | 0.65 | 12 | 38.5 |
| 30° | 19 | 0.57 | 0.65 | 12 | 39.6 |
| 30° | 14 | 0.57 | 0.65 | 12 | 41.0 |
| 30° | 8 | 0.57 | 0.65 | 12 | 41.4 |
| 30° | 19 | 0.6 | 0.96 | 37 | 17.2 |
| 30° | 14 | 0.6 | 0.96 | 37 | 17.8 |
| 30° | 18 | 0.6 | 0.96 | 37 | 19.6 |
| 30° | 14 | 0.6 | 0.96 | 37 | 20.6 |
| 30° | 8 | 0.6 | 0.96 | 37 | 21.2 |
| 30° | 8 | 0.6 | 0.96 | 37 | 23.4 |
| 30° | 19 | 0.39 | 0.81 | 51 | 22.1 |
| 30° | 15 | 0.39 | 0.81 | 51 | 22.4 |
| 30° | 8 | 0.39 | 0.81 | 51 | 24.1 |

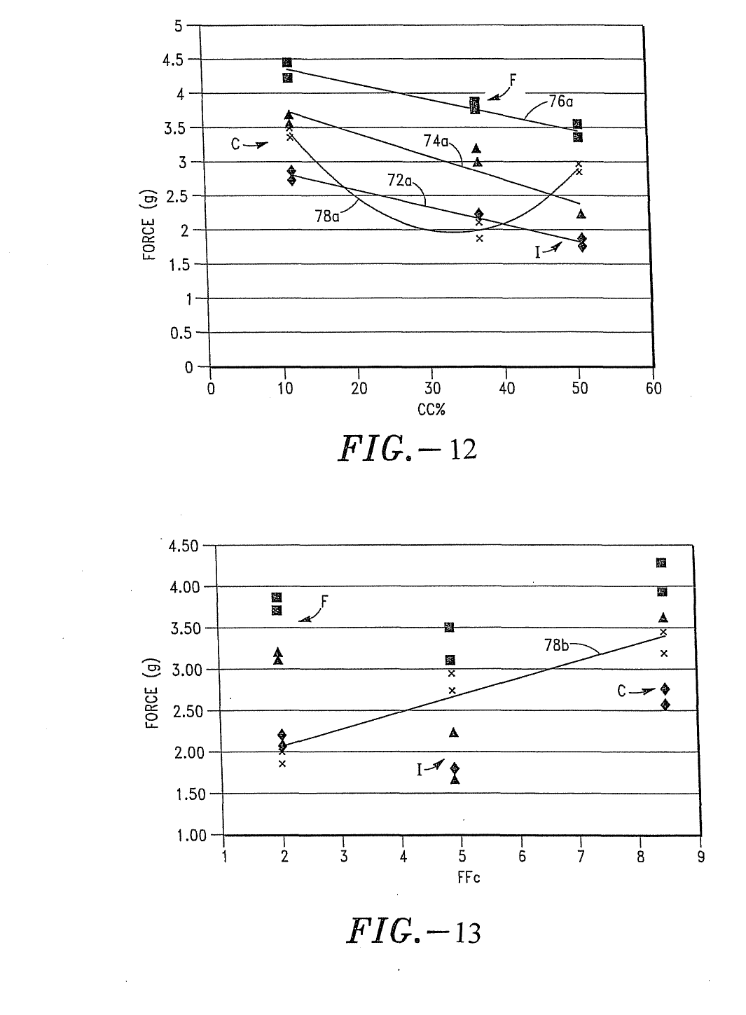

Referring now to FIGS. 8-11, there are shown graphical illustrations showing the relationship of the data provided in Tables 1 and 2. Referring first to FIGS. 8 and 9, there is shown the relationship of force to CC % for the interacting members with incidence angles of 10° and 30°, respectively. The points at CC % equal to approximately 12 (designated “C”) correspond to the coarse grade lactose, the points at CC % equal to approximately 51 (designated “I”) correspond to the intermediate grade lactose, and the points at CC % equal to approximately 37 (designated “F”) correspond to two fine grade lactose samples.

As reflected in FIG. 8, the 10° interacting member provides a linear relationship between force and CC %. The linear relationship is expressed as line 60 having a linear equation y=−0.3324x+27.027 with a regression coefficient of R²=0.9252.

As reflected in FIG. 9, the 30° interacting member similarly provides a linear relationship between force and CC %. The linear relationship is expressed as line 62 having the linear equation y=−0.5336x+44.256 with a regression coefficient of R²=0.7832.

Referring now to FIGS. 10 and 11, there is shown the relationship between force and powder velocity (expressed as rotation rate) for the 10° and 30° interacting members, respectively. Lines 64a and 64b represent the coarse grade lactose, lines 66a and 66b represent the intermediate grade lactose and lines 68a and 68b, and 70a and 70b, represent two samples of fine grade lactose.

FIGS. 10 and 11 reflect that the force imparted by the moving lactose powder is relatively independent of powder velocity; particularly, in the coarse and intermediate lactose grades and, more particularly, for the 10° interacting member.

As can be appreciated from this data, particularly in view of FIGS. 10 and 11, discussed above, an interacting member having an incidence angle of 10° generates a more linear relationship between the force imparted and the CC % of the lactose powder. Thus, measurement of drag (i.e. the resistance to motion through a fluid system) by an interacting member having a lesser angle of incidence offers a more sensitive measurement technique for assessing powder flowability as represented by CC %. Accordingly, in one embodiment of the invention, the interacting member of the invention is configured to emphasize the effect of shear forces in relation to the impact forces.

FIGS. 10 and 11 also reflect that rotational speed does not effect a major change in the force imparted by the powder at the velocities tested. This may, however, be a consequence of the relatively low linear velocities used in these experiments. The observed low response to changing speed represents a benefit for the integration of this rheometer design into the production line, as hopper speed is a control variable in immersion DPI fillers. The data thus indicates that hopper speed can be adjusted without detrimentally affecting the precision of powder loading.

### Example 2

As discussed above, interacting member designs that emphasize the transmission of shear forces provide a more linear relationship between the measured force and the compaction and compressibility of a powdered pharmaceutical composition. To further investigate the ramifications of this observation, four interacting member designs corresponding to the designs shown in FIGS. 1, 2, 3 and 5 were analyzed.

In this example, three grades of lactose of varying particle size were used as the experimental substrate. Bulk densities in the range of approximately 0.4 to 0.6 kg/m³ were evaluated to cover the typical range of densities used in most MDPI formulations. Accordingly, these densities provided a range of bulk density and flow characteristics to provide a comprehensive assessment of the interacting member designs.

Compaction/compressibility and flow function of the powdered lactose were also calculated. As is well known in the art, these are useful indicators of flow in powders and can be compared and correlated to the force feedback data.

This example was performed using a miniature immersion type filling system. The rotational speed of this system was tailored to correspond to the velocities used in conventional filling systems; particularly, towards the lower end of the typical range.

During the measurements, an optical tachometer was mounted on a tripod and directed to detect reflective tape mounted on the rotating hopper of the immersion filler. The pulse output of the optical tachometer was fed into the bench top tachometer, which provided an analog output proportional to the rotation rate that was fed into one channel of a multiplexer in a scanning digital voltmeter (DVM). The acquisition rate was 47 readings per second.

A force sensor was also interfaced with the multiplexer of the scanning DVM with an acquisition rate was 5 readings per second. The scanning DVM was set to scan during an entire set of measurements and the samples were stored locally in non-volatile memory on the scanning DVM. Each sample was time and date stamped. The force measurements associated with the different interacting member designs for each lactose grade are provided in Table 3. As indicated above, design 1 corresponded to the interacting member 12 shown in FIG. 1; design 2 corresponded to the interacting member 26 shown in FIG. 3; design 3 corresponded to the interacting member 22 shown in FIG. 2; and design 4 corresponded to the interacting member 40 shown in FIG. 5.

TABLE 3

| | | Density | | | | Force | Sample |
|---|---|---|---|---|---|---|---|
| Design | Grade | (g/ml) | CC % | FFc | RPM | (g) | size |
| 1 | Coarse | 0.65 | 12 | 8.5 | 10.11 | 2.74 | 55 |
| 1 | Fine | 0.96 | 37 | 2.0 | 10.47 | 2.21 | 61 |
| 1 | Blended | 0.81 | 51 | 4.9 | 10.86 | 1.77 | 33 |
| 1 | Fine | 0.96 | 37 | 2 | 21.12 | 2.11 | 38 |
| 1 | Coarse | 0.65 | 12 | 8.5 | 21.22 | 2.83 | 59 |
| 1 | Blended | 0.81 | 51 | 4.9 | 21.65 | 1.90 | 24 |
| 2 | Fine | 0.96 | 37 | 2.0 | 10.46 | 3.76 | 37 |
| 2 | Coarse | 0.65 | 12 | 8.5 | 10.49 | 4.20 | 26 |
| 2 | Blended | 0.81 | 51 | 4.9 | 10.81 | 3.52 | 53 |
| 2 | Fine | 0.96 | 37 | 2.0 | 21.32 | 3.85 | 42 |
| 2 | Coarse | 0.65 | 12 | 8.5 | 21.33 | 4.44 | 36 |
| 2 | Blended | 0.81 | 51 | 4.9 | 21.61 | 3.50 | 52 |
| 3 | Fine | 0.96 | 37 | 2.0 | 10.68 | 3.18 | 41 |
| 3 | Coarse | 0.65 | 12 | 8.5 | 10.70 | 3.62 | 48 |
| 3 | Blended | 0.81 | 51 | 4.9 | 11.02 | 2.23 | 41 |
| 3 | Fine | 0.96 | 37 | 2.0 | 21.41 | 3.13 | 59 |
| 3 | Coarse | 0.65 | 12 | 8.5 | 21.43 | 3.66 | 60 |
| 3 | Blended | 0.81 | 51 | 4.9 | 21.54 | 2.20 | 25 |
| 4 | Blended | 0.81 | 51 | 4.9 | 10.39 | 2.95 | 54 |
| 4 | Coarse | 0.65 | 12 | 8.5 | 10.84 | 3.33 | 28 |
| 4 | Fine | 0.96 | 37 | 2.0 | 11.15 | 2.07 | 60 |
| 4 | Coarse | 0.65 | 12 | 8.5 | 21.52 | 3.46 | 56 |
| 4 | Fine | 0.96 | 37 | 2.0 | 21.54 | 1.87 | 57 |
| 4 | Blended | 0.81 | 51 | 4.9 | 21.56 | 3.18 | 37 |

As reflected in Table 3, the change in linear velocity between the boundary conditions of approximately 0.08 m/s, which corresponds to a hopper rotation rate of approximately 9 rpm, and 0.17 m/s, which corresponds to a rotation rate of approximately 21 rpm, does not significantly change the mean data collected during the run.

The data provided in Table 3 also indicates that a discrete average approach gives rise to the most appropriate trending through a batch. A discrete average approach, as employed herein, means taking the average of a statistically significant number of samples (e.g. 50 points) as a function of time. As will be appreciated by one having skill in the art, the number of samples will be dependant on the signal-to-noise ratio. The period of time will be dependant on the equipment employed.

As reflected in Table 3, a sample size=50 provides a representative mean value for the system used. Accordingly, data acquisition rate is deemed a critical aspect of the rheological measurements of the invention due to the nature of the discrete average in time series analysis. In larger, full scale filling processes, a higher frequency of data capture is desirable to attain a suitable output frequency for process trending.

Referring now to FIGS. 12-15, there are shown graphical illustrations reflecting the relationships of the data provided in Table 3. The points at CC % equal to approximately 12 (designated “C”) correspond to the coarse grade lactose, the points at CC % equal to approximately 51 (designated “I”) correspond to the intermediate grade lactose, and the points at CC % equal to approximately 37 (designated “F”) correspond to fine grade lactose samples.

Referring first to FIG. 12, there is shown the relationship of force to CC % for design 1 (represented by line 72a), design 2 (represented by line 76a), design 3 (represented by line 74a) and design 4 (represented by curve 78a), which, as indicated above, correspond to interacting members 12, 26, 22 and 40, respectively. As reflected in FIG. 12, lines 72a, 74a and 76a all reflect a substantial fit to the data and indicate that a relatively linear relationship between force and CC % can be obtained with designs 1, 2 and 3. Design 2, as expressed by line 74a, provides the most linear relationship.

As also reflected in FIG. 12, design 4 (represented by curve 78a) does not generate a linear relationship between force and CC %. However, as discussed below, a linear relationship between force and flow function was provided by design 4.

Referring now to FIG. 13, there is shown the relationship of force to flow function (FFc) for designs 1-4. The points at FFc equal to approximately 2 (designated “F”) correspond to the fine grade lactose, the points at FFc equal to approximately 4.9 (designated “I”) correspond to the intermediate grade lactose, and the points at FFc equal to approximately 8.5 (designated “F”) correspond to fine grade lactose samples.

As reflected in FIG. 13, designs 1, 2 and 3 do not yield a linear relationship between force and FFc. However, design 4 did yield a linear relationship. The linear relation is expressed as line 78b having a linear equation y=0.2023x+1.6762 with a regression coefficient of R²=0.9065.

Accordingly, a linear relationship exists between the force generated by design 4 and FFc. The data accordingly reflects that design 4 can be effectively employed to monitor FFc online (and in real-time) during a DPI filling process to track changes over the course of a batch or over a series of batches.

Referring now to FIG. 14, there is shown the relationship of force to bulk density for designs 1-4. The points at bulk density equal to approximately 0.65 kg/m³ (designated “C”) correspond to the coarse grade lactose, the points at bulk density equal to approximately 0.81 kg/m³ (designated “I”) correspond to the intermediate grade lactose, and the points at bulk density equal to approximately 0.96 kg/m³ (designated “F”) correspond to fine grade lactose samples.

As reflected in FIG. 14, designs 1, 2 and 3 similarly do not yield a linear relationship between force and bulk density. Design 4 again yielded a linear relationship, which is expressed as line 78c having the linear equation y=−4.3377x+6.3191 with a regression coefficient of R²=0.9571.

The data accordingly reflects that design 4 can also be employed to obtain a relatively linear relationship between measured force and bulk density.

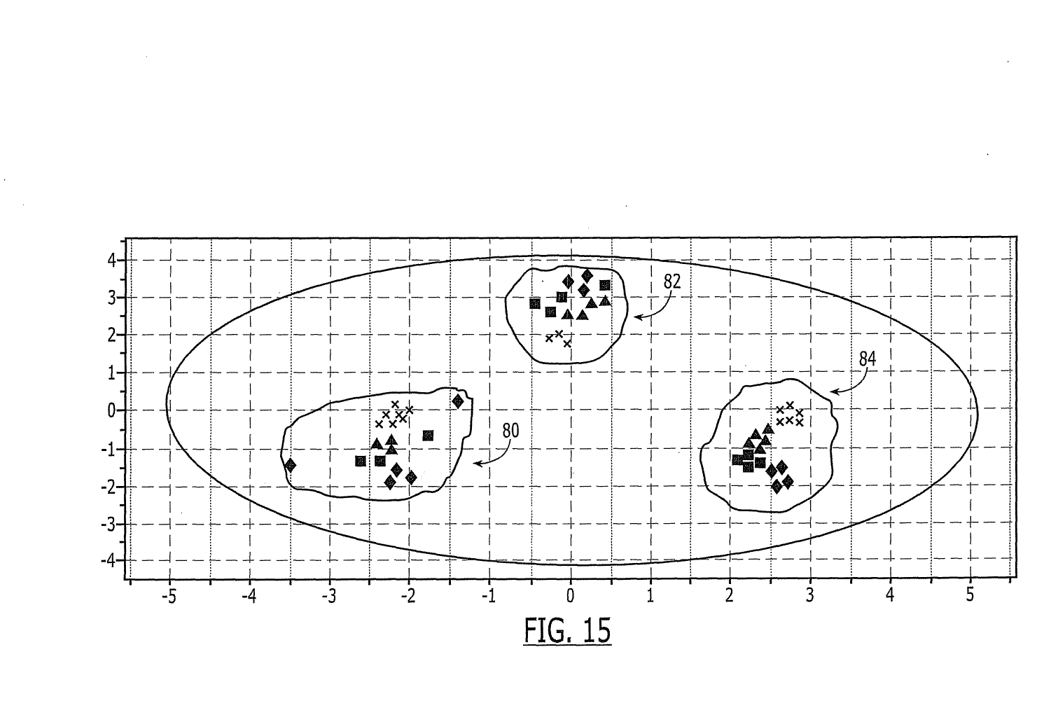

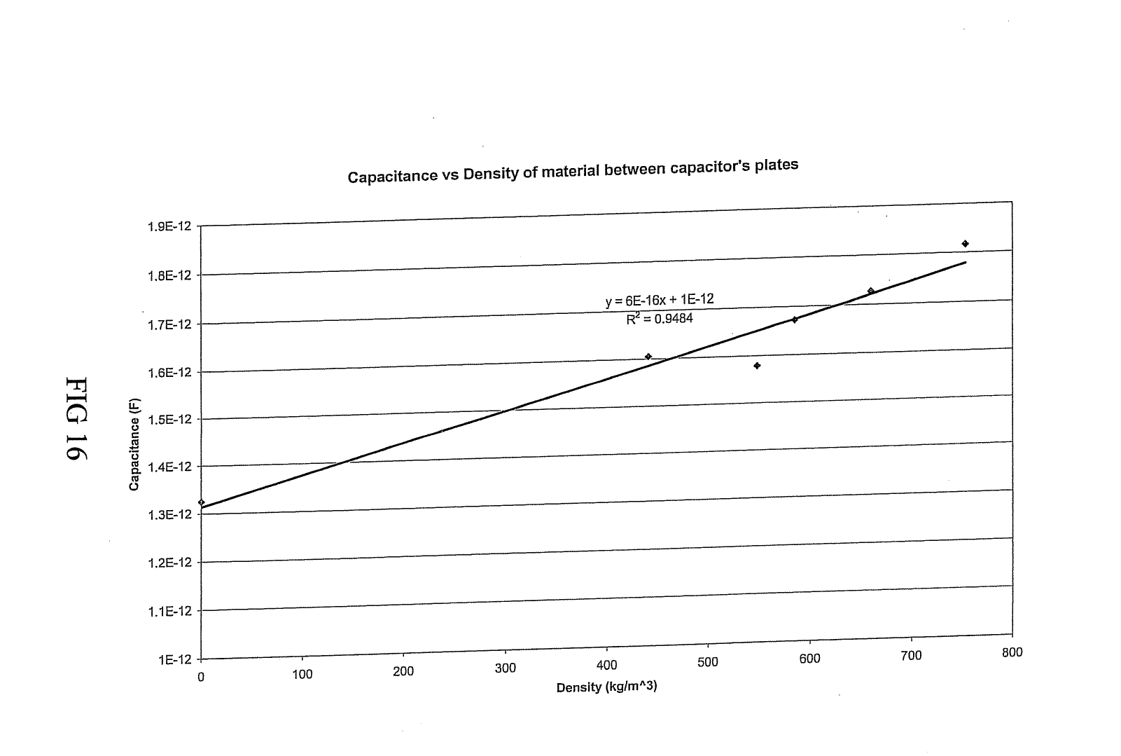

Referring now to FIG. 15, there is shown a multivariate relationship of the force generated by each interacting member design. As illustrated in FIG. 15, distinct grouping patterns can be readily identified that correspond to the different grades of lactose used. The grouping of data designated 80 represents measurements of coarse grade lactose, having a variable tapped bulk density in the range of approximately 0.65 to 0.712 kg/m³. The grouping of data designated 82 represents intermediate grade lactose, having a variable tapped bulk density in the range of approximately 0.774 to 0.836 kg/m³. The grouping of data designated 84 represents fine grade lactose, having a variable tapped bulk density in the range of approximately 0.898 to 0.96 kg/m³.

As one having ordinary skill in the art will appreciate, this data indicates that the multivariate model is feasible for differentiating between lactose of different physical properties and particle size distribution. Accordingly, the rheological measurements of the invention can be incorporated readily into a statistical process control tool for detecting process signatures.

### Example 3

To investigate the relationship between measured capacitance and bulk density of powered materials a rheometer of the invention having an interacting member with a design corresponding to interacting member 52 shown in FIGS. 7A and 7B was provided.

Three grades of lactose, having varying particle sizes (i.e., fine, intermediate and coarse), were also provided. As set for the in Table 4, the bulk density of the lactose grades ranged from approximately 441 to 753 kg/m³.

TABLE 4

| Dielectric Material | Bulk Density |
|---|---|
| Air | 0 kg/m³ |
| Fine lactose | 441 kg/m³ |
| 75% fine, 25% coarse lactose | 548 kg/m³ |
| 50% fine, 50% coarse lactose | 585 kg/m³ |
| 25% fine, 75% coarse lactose | 660 kg/m³ |
| Coarse lactose | 753 kg/m³ |

The rheometer was integrated into a mini MKII blending system. The plates of the interacting members were disposed within the rotating system, which was filled with a selective lactose blend.

Referring now to FIG. 16, there is shown the relationship of measured capacitance to bulk density of the lactose. As illustrated in FIG. 16, a substantially liner relationship was found between capacitance and bulk density.

Without departing from the spirit and scope of this invention, one having ordinary skill in the art can make various changes and modifications to the invention to adapt it to various usages and conditions. As such, these changes and modifications are properly, equitably, and intended to be, within the full range of equivalence of the following claims.

What is claimed is:

1. A system for determining a rheological property of a powdered material, comprising:
a powder interacting member that is adapted to be disposed within a moving quantity of the powdered material, whereby a force is imparted on said powder interacting member by said moving powered material, said powder interacting member having a shear/impact ratio in the range of 1.0-6.0; and
force monitoring means adapted to be in communication with said powder interacting member for measuring said force imparted on said powder interacting member by said moving powered material, said force monitoring means being further adapted to generate at least one signal representative of a rheological property of the powdered material when said force is imparted on said powder interacting member by said moving powered material.

2. The system of claim 1, wherein said powered material comprises a particulate pharmaceutical composition.

3. The system of claim 1, wherein said rheological property is selected from the group consisting of viscosity, flowability and Carr's compressibility index.

4. The system of claim 1, wherein said shear/impact ratio of said powder interacting member is in the range of approximately 1.73-5.67.

5. The system of claim 1, wherein said powder interacting member has an angle of incidence in the range of approximately 10-30°.

6. The system of claim 1, wherein said force monitoring means comprises mechanical force monitoring means.

7. The system of claim 1, wherein said force monitoring means comprises electro-mechanical force monitoring means.

8. The system of claim 7, wherein said electro-mechanical force monitoring means includes a pivoting shaft secured to said powder interacting member and a load cell that is in communication with said pivoting shaft, said load cell being adapted to generate at least one signal representative of a rheological property of the powdered material when said moving powered material imparts said force to said powder interacting member.

9. The system of claim 1, wherein said powder interacting member has a three-sided pyramidal shape that tapers to a leading point.

10. The system of claim 9, wherein said powder interacting member has an overall length in the range of approximately 10-100 mm.

11. The system of claim 1, wherein said powder interacting member includes a base and a U-shaped blade portion extending from said base.

12. The system of claim 11, wherein said U-shaped blade portion has a height in the range of approximately 5-100 mm, a length in the range of approximately 2-50 mm and a width in the range of approximately 2-50 mm.

13. The system of claim 1, wherein said powder interacting member has a generally spherical shape.

14. The system of claim 1, wherein said powder interacting member has a generally conical shaped leading portion that transitions to a constant diameter portion.

15. The system of claim 14, wherein said conical portion has a length in the range of approximately 10-100 mm and a cone angle in the range of approximately
0-45°, and said constant diameter portion has a length in the range of approximately
5-80 mm and a diameter in the range of approximately 2-50 mm.

16. The system of claim 1, wherein said moving quantity of the powdered material is involved in a manufacturing process.

17. The system of claim 16, wherein said manufacturing process comprises filling a dry powder inhaler with said powdered material.

18. The system of claim 16, wherein said force monitoring means signal is provided in real-time during said manufacturing process.

19. A system for determining a rheological property of a powdered material, comprising:
a powder interacting member that is adapted to be disposed in a moving quantity of the powdered material; and
electrical monitoring means adapted to interact with said powder interacting member and determine at least one electrical property representing at least one rheological property of the powdered material when said powder interacting member is disposed in said moving powdered material.

20. The system of claim 19, wherein said powered material comprises a particulate pharmaceutical composition.

21. The system of claim 19, wherein said electrical property is associated with said interacting member.

22. The system of claim 19, wherein said rheological property is selected from the group consisting of viscosity, flowability and Carr's compressibility index.

23. The system of claim 19, wherein said system includes mechanical force monitoring means.

24. The system of claim 19, wherein said system includes mechanical force monitoring means.

25. A system for determining a rheological property of a powdered material, comprising:
a powder interacting member having two electrically conductive members that are adapted to be disposed in a moving quantity of the powdered material; and
electrical monitoring means adapted to measure the capacitance between said two electrically conductive members when said electrically conductive members are disposed in said moving powdered material, said capacitance representing at least one rheological property of said powdered material.

26. The system of claim 25, wherein said powered material comprises a particulate pharmaceutical composition.

27. The system of claim 19, wherein said rheological property is selected from the group consisting of viscosity, flowability and Carr's compressibility index.

28. The system of claim 25, wherein said system includes mechanical force monitoring means.

29. The system of claim 25, wherein said system includes electro-mechanical force monitoring means.

30. A method for determining a rheological property of a powdered material, comprising the steps of:
providing a moving quantity of said powdered material;
providing a rheometer having a powder interacting member, said powder interacting member being adapted to be disposed in said moving powdered material, whereby a force is imparted on said powder interacting member by said moving powdered material, and force monitoring means adapted to be in communication with said powder interacting member for measuring said force imparted on said powder interacting member by said moving powdered material, said force monitoring means being further adapted to generate at least one signal representative of a rheological property of said powdered material when said force is imparted on said interacting member by said moving powdered material;
disposing said powder interacting member in said moving powdered material; and
detecting said signal generated by said force monitoring means.

31. The system of claim 30, wherein said powered material comprises a particulate pharmaceutical composition.

32. The method of claim 30, wherein said rheological property is selected from the group consisting of viscosity, flowability and Carr's compressibility index.

33. The method of claim 30, wherein said powder interacting member is configured to have a shear/impact ratio in the range of approximately 1.73-5.67.

34. The method of claim 33 wherein said powder interacting member has an angle of incidence in the range of approximately 10-30°.

35. The method of claim 30, wherein said moving quantity of powdered material is involved in a manufacturing process.

36. The system of claim 35, wherein said manufacturing process comprises filling a dry powder inhaler with said powdered material.

37. The system of claim 35, wherein said force monitoring means signal is provided in real-time during said manufacturing process.

38. The method of claim 35, further comprising the step of adjusting said manufacturing process in response to said detected signal.

39. A method for determining a rheological property of a powdered material, comprising the steps of:
providing a moving quantity of the powdered material;
providing a rheometer having a powder interacting member and electrical monitoring means adapted to interact with said powder interacting member and determine at least one electrical property of said powder interacting member representing at least one rheological property of the powdered material when said powder interacting member is disposed in said moving powdered material;
disposing said powder interacting member in said moving powdered material; and
measuring said electrical property.

40. The system of claim 39, wherein said electrical property comprises capacitance.

41. The system of claim 39, wherein said powered material comprises a particulate pharmaceutical composition.

42. The method of claim 39, wherein said rheological property is selected from the group consisting of viscosity, flowability and Carr's compressibility index.

43. The method of claim 39, wherein said moving quantity of powdered material is involved in a manufacturing process.

44. The system of claim 43, wherein said electrical property is determined in real-time during said manufacturing process.

45. The method of claim 44, further comprising the step of adjusting said manufacturing process in response to said electrical property.

46. A method for determining a rheological property of a powdered material, comprising the steps of:
providing a moving quantity of the powdered material;
providing a rheometer having a powder interacting member, said interacting member having two electrically conductive members that are adapted to be disposed in said moving powdered material, and electrical monitoring means adapted to measure the capacitance between said electrically conductive members when said electrically conductive members are disposed in said moving powdered material;
disposing said electrically conductive members in said moving powdered material; and
measuring said capacitance between said electrically conductive members, said capacitance representing at least one rheological property of the powder.

47. The method of claim 46, wherein said moving quantity of powdered material is involved in a manufacturing process.

48. The method of claim 47, wherein said capacitance is measured in real-time during said manufacturing process.

49. The method of claim 48, further comprising the step of adjusting said manufacturing process in response to said measured capacitance.
